(19) United States
(12) Patent Application Publication
(10) Pub. No.: US 2011/0294925 A1
(43) Pub. Date: Dec. 1, 2011

(54) COMPOSITE FROM HEMICELLULOSE EXTRACTED WOOD WITH IMPROVED PERFORMANCE AND REDUCED EMISSIONS

(76) Inventors: Stephen M. Shaler, Old Town, ME (US); Juan J. Paredes, San Pedro Sula (HN); Adriaan Reinhard Pieter van Heiningen, Orono, ME (US)

(21) Appl. No.: 12/952,891

(22) Filed: Nov. 23, 2010

Related U.S. Application Data
(60) Provisional application No. 61/263,651, filed on Nov. 23, 2009.

(51) Int. Cl. C08L 97/02; C08L 61/12; C08L 61/14; D21B 1/04

(52) U.S. Cl. 524/14; 264/115

(57) ABSTRACT

A composite article includes cellulosic strands and binder, the strands having been extracted to remove hemicellulose. In certain embodiments, the cellulosic strands are wood strands. The article may have reduced production of volatile organic compound emissions compared to the same article made with non-extracted strands. Also, the article may have improved performance after exposure to moisture. A method of manufacturing a composite article comprising extracting cellulosic strands to remove hemicelluose, and forming a composite which includes the strands and a binder. In certain embodiments, the extraction is a hot water extraction.

### CROSS-REFERENCE TO RELATED APPLICATION

This application claims the benefit of U.S. Provisional Application No. 61/263,651, filed Nov. 23, 2009, the disclosure of which is incorporated herein by reference.

### BACKGROUND OF THE INVENTION

This invention relates in general to cellulosic composites, and in particular to wood composites such as oriented strand boards with improved performance and/or reduced emissions.

Since the first oil well in the world was drilled in Pennsylvania in 1859, the world has been depleting the finite supply of oil. Fossil fuels are classified as non-renewable resources because they take millions of years to form, and reserves are being depleted much faster than new ones are being found. The world economy depends on fossil fuel, but the recent increases in the price of petroleum and concerns regarding climate change due to carbon emission are focusing research on providing renewable sources of materials and energy from sustainably managed forest and other biomass feedstocks.

Biorefineries use biomass from grains such as corn, wheat, barley, oils, sugar cane, and agricultural residues. But the use of grains, oils, and sugar cane for energy reduces their availability for use as food or animal feed. Biofuel from wood does not diminish the world's food supply and is a good source of biomass raw material. The utilization of wood in biofuel will not be viable economically unless the remaining solids are used for other goods or there is a dramatic energy price increase.

The global forest product industry currently produces materials such as lumber, pulp and paper, wood composites, etc. Also, they produce energy used within the manufacturing plant and for home heating (e.g. pellets). The concept of a forest bio-refinery can be applied by a modification or incorporation of sugars extraction and its fermentation within the traditional forest industry to enhance the profitability of wood products and biofuels. Although cellulosic biomass is abundant, 370 million dry tons per year forest-derived biomass harvested in the U.S., it is a complex feedstock that requires more extensive processing than corn grain, the primary feedstock for fuel ethanol production in the U.S. Scientific breakthroughs are needed to make cellulosic ethanol production cost-efficient enough to operate on a commercial scale.

Over the last 30 years, several programs and standards have been recognized and/or modified to set criteria for emissions produced during manufacturing of wood products. Emissions include particulate matter (PM), carbon monoxide (CO), nitrogen oxides (NOx) and volatile organic compounds (VOCs).

The manufacture of oriented strand board (OSB) produces VOC emissions from energy production, wood drying, resin blending, board pressing, and product storage. The combustion of a wood waste boiler produces concentrations of formaldehyde up to 80 ppm and up to 350 ppm of total hydrocarbons. Wood drying produces formaldehyde emissions up to 1 g/kg of dried wood and non-methane organic emissions from 0.3 to 5.7 g/kg.

Recently, VOC emissions from press stacks during OSB manufacture have been the focus of much research. In a study of the VOC emissions from OSB during hot pressing, it was found that formaldehyde emissions increased with increasing press temperature, mat moisture content, resin solids levels (phenol-formaldehyde resin), and pressing time. Wood species significantly influence the amount of VOC emissions, as differing species exhibit varying amounts of volatile and semivolatile extractive compounds.

It would be desirable to provide wood composites with improved performance and/or reduced emissions.

### SUMMARY OF THE INVENTION

This invention relates to a composite article comprising cellulosic strands and binder, the strands having been extracted to remove hemicellulose. In certain embodiments, the cellulosic strands are wood strands. The article may have reduced production of volatile organic compound emissions compared to the same article made with non-extracted strands. Also, the article may have improved performance after exposure to moisture.

The invention also relates to a method of manufacturing a composite article comprising extracting cellulosic strands to remove hemicelluose, and forming a composite which includes the strands and a binder. In certain embodiments, the extraction is a hot water extraction.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a graph showing a time/temperature profile and a time/pressure profile obtained during fabrication of a wood composite according to the invention.

FIG. 2 is a block diagram of a system used to produce the wood composite.

FIG. 3 is a graph of results obtained with the wood composite.

### DETAILED DESCRIPTION OF THE PREFERRED EMBODIMENT

The present invention relates to a composite article comprising cellulosic strands and binder, the strands having been extracted to remove hemicellulose. Any suitable cellulosic strands can be used. The term “strands” as used herein includes fibers. Some nonlimiting examples of cellulosic strands are those produced from wood, sugar cane residue (bagasse), hemp stalks, straw, cornstalks and sunflower stalks. Some examples of wood species include both hardwoods and softwoods, such as red maple (Acer rubrum L.), aspen (Populus tremuloides), southern yellow pine (Pinus spp.), loblolly pine (Pinus taeda), and hemlock (Tsuga canadensis), and the like.

The strands can be included in any suitable amount in the composite article. In some embodiments, the strands are included in an amount within a range of from about 40% to about 85% by dry weight of the consolidated fibrous article, and particularly from about 45% to about 75%.

Any type of binder, or any combination of different binders, suitable for making a composite article can be used. Some nonlimiting examples of binders are starch binders such as corn starch, wheat starch and potato starch; and synthetic resins such as urea formaldehyde, melamine formaldehyde, phenol formaldehyde, methylene diphenyl diisocyanate, and polyurethane resin. Some specific examples of polymeric resin binders that may be used include polymeric diphenylmethane diisocyanate and phenol-resorcinol-formaldehyde.

The cellulosic strands and binder are provided in any suitable arrangement in the composite article. In certain embodiments, the cellulosic strands are arranged in a mat. The production of woven and nonwoven mats made from strands is known in the composite industry. In certain embodiments, the strands are oriented strands and the composite article is a panel or board. For example, in the manufacture of oriented strand boards, the strands are layered in specific orientations and the strands and binder are formed into a sheet, which is then compressed under pressure and high temperature.

The strands are extracted to remove hemicellulose prior to their use in manufacturing the composite article. The hemicellulose extraction can be accomplished in any suitable manner. In certain embodiments, the hemicellulose is extracted with a hot water extraction process. The hot water extraction can be conducted using any suitable conditions. For example, the extraction may be conducted using water at a temperature within a range of from about 110° C. to about 200° C. and a time of extraction within a range of from about 30 minutes to about 150 minutes. In other embodiments, a basic material such as an alkali material could be added to the water for use in the extraction.

The amount of hemicellulose extracted from the strands can be any suitable amount. In certain embodiments, the process extracts at least about 4%, more particularly at least about 8%, of the hemicellulose as measured on a dry material weight basis.

The extraction of hemicellulose from the cellulosic strands can include either extraction after the cellulosic material has been formed into strands, or extraction before the cellulosic material has been formed into strands.

The composite article made with the extracted strands can have reduced production of volatile organic compound emissions compared to the same article made with non-extracted strands. For example, when the composite article is a board or panel, the panel may have a volatile organic compound emission of less than about 17 mg/kg of wood.

The composite article made with the extracted strands also can have improved performance after exposure to moisture compared to the same article made with non-extracted strands. For example, when the composite article is a board or panel, the panel may have a thickness swell below about 8%, and more particularly below about 4%.

The composite article made with the extracted strands also can have a lower density compared to the same article made with non-extracted strands with equivalent or improved properties. For instance, as described in the Examples below, strength properties of the article may be increased significantly at equivalent density values.

Moreover, the use of the extracted strands in the composite article can allow the production of an article without the use of wax. In standard oriented strand board production, water absorption and thickness swell are mitigated through the use of wax, which both interferes with bonding and is expensive. Due to the improved water absorption properties of the extracted panels of this invention, wax may no longer be necessary.

The following non-limiting examples provide further description of the invention and represent best modes contemplated by the inventors for practice of the invention.

### EXAMPLES

This research presents a process of hemicellulose extraction prior to OSB manufacture with the aim of reducing VOC emissions. The mass loss resulting from the extraction process was calculated and a sugar analysis of the extracted compounds was conducted. Finally, the physical and mechanical properties of the manufactured panels were determined. Industrial southern yellow pine, SYP (Pinus spp.), strands were donated by J M Huber, Commerce, Georgia. The strands were sampled after the mill's core dryer. A majority of fines were removed using an Acrowood Trillium and Diamond Roll combination screen. Typical strand geometries were 10.1±0.3 cm long, 1-4 cm wide, and 0.7±0.1 mm thick.

Huntsman rubinate polymeric diphenylmethane diisocyanate (pMDI) resin was used, having a viscosity of 334 cps and NCO content of 31.2%. The viscosity of the resin was determined on a Brookfield DV-I+viscometer, model LV, using a #3 (LV) spindle at 60 rpm, resin temperature of 22.2° C. Hexion EW-45 emulsified wax (45% solids) was also used.

### Extraction Process

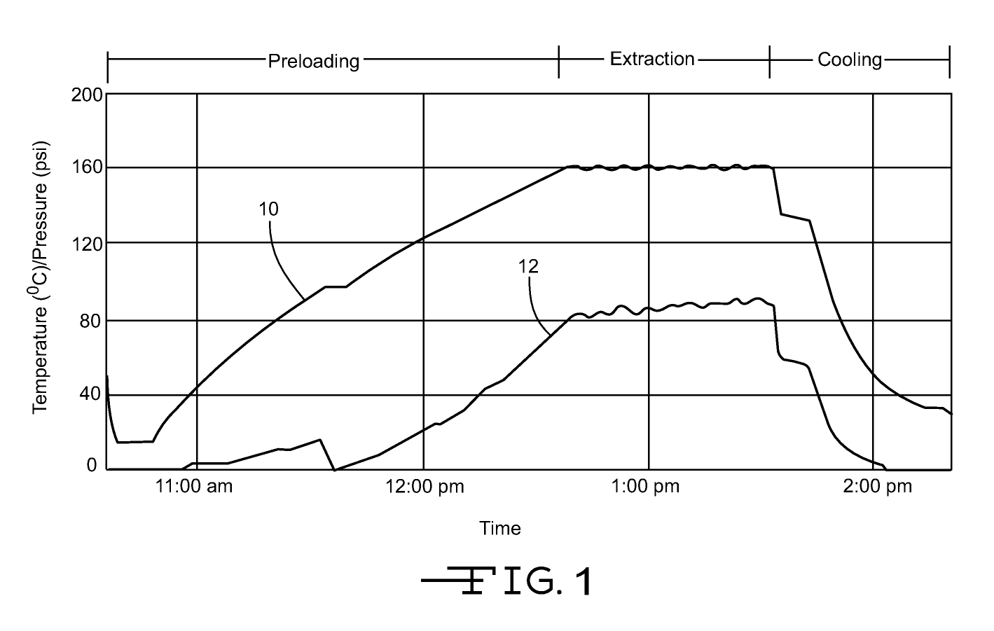

Two hot water extraction (HWE) procedures, short and long time, were employed using a custom built rotating extractor (digester) spinning at 2 rpm. The strands, in 6.2 kg batches, were placed inside a high pressure vessel filled with fresh water with a water/wood ratio of 4:1. The moisture in the wood was included in the ratio calculation. The vessel was heated from room temperature to 160° C. in 2.0 hours, followed by constant temperature exposure times of 22.9 min or 53.6 min, respectively. FIG. 1 is a graph showing an example of a time/temperature profile 10 and a time/pressure profile 12 during the preheating, extraction and cooling stages of an extraction process.

Seven and fifteen extraction runs were conducted for the short and long times, respectively, giving a total of 22 samples. Extraction time and temperature can be expressed through use of a single variable known as the severity factor (SF):

$$SF = log ( {\int }_{0}^{t} Exp [ \frac{{T}_{r} - {T}_{b}}{14.75} ] d t ) \qquad ( 1 )$$

where: t is residence time (minutes), Tr is the reaction temperature (° C.), and Tb is Base temperature (100° C.). The temperature difference is 14.75 (° C.) derived from [(Tr·Tb·R)/Ea] (R is the gas constant and Ea is energy activation), assuming that the overall process is hydrolytic and the overall conversion is pseudo first order. Bonds on SF equation are from 0 (unextracted wood) to 4.

Water temperature was measured inside of the vessel at 0.01 second intervals. Using Eq (1), —including preheating, extraction and cooling time, a low SF (LSF) of 3.29 was calculated for the short time and a higher SF (HSF) of 3.59 for the longer extraction time.

Analysis of the Liquid Extract Weight loss of the strands as a result of the extraction process was determined for each extraction run by freeze drying (LABCONCO model LYPH-lock 6) the extracted liquid at −42° C. between 13 and 19×10⁻³ Mbar of vacuum. The carbohydrate composition of the liquid extract was a parameter for evaluating VOC emissions and OSB properties. High-performance liquid chromatography (HPLC) was used to analyze sugar, lignin, and acetic acid because of the simplicity of sample preparation and the ease of adopting a routine. Sugar analysis was conducted using a single specimen on an HPLC-Shimadzu whose system consisted of a pump, manual injector, refractive index detector and two independent columns: (1) BioRad Aminex HPX-87H, at 60° C. and 0.6 mL/min, using 5 mM of H₂SO₄ and (2) BioRad Aminex HPX-87P, operated at 80° C. and 0.6 mL/min, using deionized (dI) water. Analysis of glucose, xylose, mannose, and arabinose, was taken from the second column while the result of lignin and acetic acid were taken from the first column.

OSB Manufacture

Control (unextracted) OSB strands were conditioned in a dehumidification dry kiln, at 32.2° C. and a relative humidity (RH) of 33% for six days until constant weight was attained. The average moisture content of the strands was 6.2±0.1%. Extracted OSB strands were conditioned using the same dehumidification dry kiln set at 32.2° C. and a RH of 35%, again for six days until constant weight was attained. The average moisture content of the extracted stands was 6.3±0.1% and 6.0±0.1% for LSF and HSF conditions, respectively. Enough strands (39.7 kg) to produce three panels were placed within a Coil spinning disk atomizing resin blender. Polymeric diphenylmethane diisocyanate (pMDI) adhesive (Huntsman Rubinate) and Hexion EW-45H emulsified wax were added at a loading of 4% and 1% (solids content based on oven dry wood weight), respectively. Resin was applied using a disk speed of 12,000 rpm, a drum speed of 20 rpm, with resin pumped to the blender at a feed rate of 200 ml/min. The E-wax was applied using a Spraying Systems air atomizer at a feed rate of 120 ml/min, for a total blend time of approximately seven min. Panels were formed manually atop a 1.2 mm thick steel caul plate, sprayed with a thermosetting mold release (Stoner E497). A 19 mm thick aluminum picture frame VOCs collection caul was then placed around the mat, which also served as a mechanical stop. A matching steel caul plate was then placed atop the mat.

The random-oriented mat was placed in a 1600 tons capacity, 121.9 cm by 243.8 cm (Erie Mill and Press) hydraulic hot press for panel manufacture. The press platen was heated to 204.4° C. using two Mokon hot oil heaters, each with two zones. The PLC-controlled press collected the temperature of each platen (4 thermocouples embedded in each), position, pressure, core temperature, and core vapor at one second intervals. The core temperature and vapor pressure during the process was measured using a probe inserted into the mat. The same press schedule was used for each run (Table 1).

TABLE 1
Press cycle

| | Ramp time | Dwell time | Mat thickness |
|---|---|---|---|
| Stage | (Min:s) | (Min:s) | (mm) |
| Close | 0:45 | 0:01 | 100.0 to 19.0 |
| Cook | 0:01 | 3:30 | 19.0 |
| Degas 1 | 0:15 | 0:01 | 19.3 |
| Degas 2 | 0:15 | 0:01 | 19.6 |
| Degas 3 | 0:15 | 0.01 | 19.8 |
| Caul evacuation | 0:45 | 0.01 | 19.8 |

VOC Collection

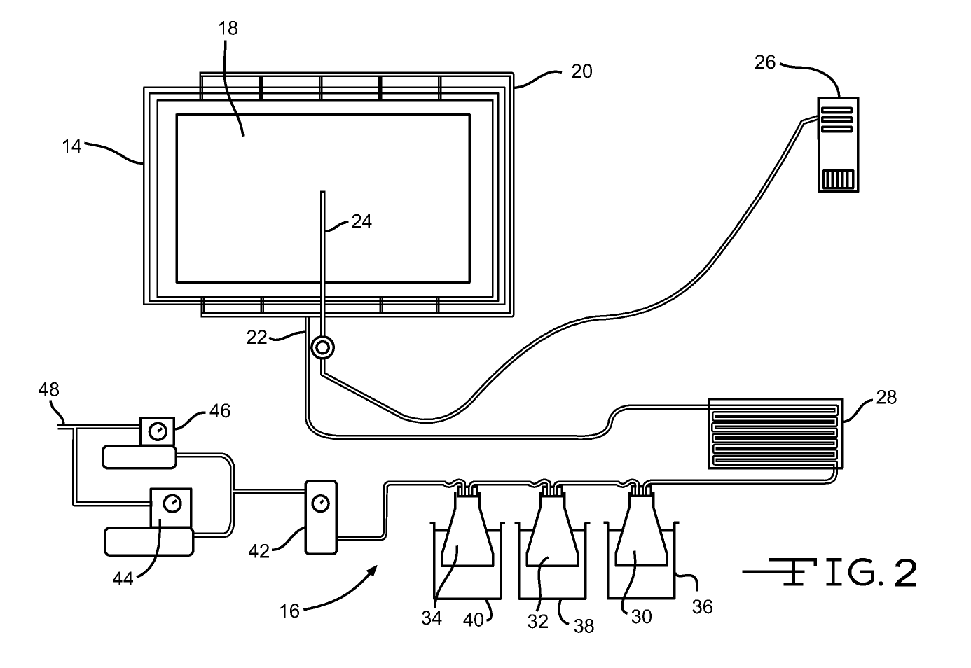

As shown in FIG. 2, the select VOCs collection system had two basic parts: a gasketed picture frame caul 14 and a VOC vapor collection apparatus 16.

The gasketed caul frame 14 was made from aluminum with interior dimensions of 104.1 cm by 226.1 cm. The size of the mat 18, 81.3 cm by 121.9 cm long by 19 mm thick at a density of 640.7 kg/m3 (at 6% MC), was chosen such that sufficient airspace existed between the mat 18 and the caul 14 to provide for unobstructed flow of VOCs around the mat and to/from the intake ports 20 and outlet ports 22. A measurement probe 24 for measuring temperature and gas pressure was inserted into the mat 18 inside the caul 14 and connected to a computer 26. The emissions exited the caul 14 through the outlet ports 22, flowed through a heat exchanger 28, and were collected in sequential order in three flasks 30, 32 and 34. Flasks 30 and 34 contained 800 ml water and were positioned in ice water baths 36 and 40, and flask 32 contained 550 ml methylene chloride and was positioned in a hot water bath 38. The collection system also included a flow meter 42 after the flasks, two vacuum pumps 44 and 46 and an exhaust hose 48. Immediately after the press cycle had finished, the VOCs collection was stopped. All flasks were then weighed, their volume recorded and their contents poured into a 4 L separation funnel. The separation funnel was agitated by hand and then allowed to sit for 30 min. Fresh methylene chloride, 300 ml, was added to the separation funnel, which was again agitated and allowed to sit for an additional 30 minutes. Select VOCs analysis was done by gas chromatography/mass spectrometry (GC/MS) conducted on an Agilent 6890 equipped with an Agilent 5973 mass spectrometer. From three replicates of each treatment, the phenol content was analyzed from the methylene chloride fraction while all other compounds, methanol, formaldehyde, and acetaldehyde, were analyzed from the water fraction.

Physical and Mechanical Property Determination

Panels were cut into specimens according to a cut-up plan to be tested in flexure, APA test S-6, internal bond, water absorption and thickness swell. All specimens were conditioned at 21±2° C., and a relative humidity of 65±5% until constant weight was attained. Half of the specimens for mechanical testing and all of the specimens for physical testing were water soaked for 24-hours at 20±2° C. following ASTM D1037-06A (ASTM 2006) and APA test S6, APA PRP-108 (APA—The engineered Wood Assoc. 2001) procedures. A 5 by 5 cm specimen was excised from both ends of flexure specimens to determine the vertical density profile using a QMS Density Profile system—v2.01 USB.

Hot Water Extraction

HWE of southern yellow pine (SYP) exhibited similar behavior to other species such as red maple (Acer rubrum) strands and loblolly pine (Pinus taeda) chips in that weight loss was proportional to extraction time. The influence of the severity factor (SF) on weight loss is summarized in Table 2.

TABLE 2
Influence of SF on weight loss

| | | | Extraction | Weight |
|---|---|---|---|---|
| Severity Factor | Treatment | Extractions | Time (min) | Loss (%) |
| 3.29 ± 0.054 | LSF | 7 | 22.93 | 6.3 ± 0.1 |
| 3.69 ± 0.04 | HSF | 15 | 53.58 | 9.3 ± 0.9 |

The weight loss was significantly different (P=0.0001) for the LSF and HSF conditions, conditions, based on a one-way analysis of variance (ANOVA) procedure. Other factors such, as species, softwood versus hardwood, and type of extraction system (open or closed) also influence weight loss. In general, under hygrothermal treatment softwoods exhibit less mass loss than hardwoods. This is mainly due to two factors: first, hardwoods are less thermally stable than softwoods, and second, the hemicellulosic content and composition differ.

Carbohydrates

Quantities of sugars and acid extracted from the SYP strands are summarized in Table 3. The production of acids occurs when wood is heated in the presence of water, resulting in a cellular breakdown and/or solubilization of hemicelluloses, lignin, water of constitution, and volatile extractives. Of the three major biopolymers of wood, cellulose, hemicellulose and lignin, hemicelluloses were more readily extracted.

TABLE 3
Amount of chemical components
removed by HWE process.

| | LSF | HSF |
|---|---|---|
| Compounds | g/kg wood | g/kg wood |
| Glucose | 8.29 | 12.83 |
| Xylose | 11.97 | 17.11 |
| Galactose | 4.23 | 6.19 |
| Arabinose | 9.14 | 6.41 |
| Mannose | 22.41 | 32.36 |
| Total sugars | 56.04 | 74.90 |
| Acetic acid | 4.01 | 8.89 |
| Lignin | 3.42 | 8.67 |
| Total (WL) | 63.47 | 92.46 |

The formation of acetic acid during hygrothermal treatment in softwood is due to cleavage of acetyl groups are located at either the C-2 or C-3 positions of the glucose and mannose units of galactoglucomannan. Galactoglucomannan comprises 5-10% of the wood weight, with an average of one acetyl group for every four backbone units. The quantity of extracted sugars increased as the SF increased, with the exception of arabinose. The reduction is likely due to degradation at the longer extraction time. At both SFs, galactoglucomannan (comprised of mannose, glucose and galactose) and xylose, all hydrolyzed under these acidic conditions. Galactoglucomannan are six carbon sugars, called hexoses, may be fermented to ethanol rapidly and efficiently using traditional yeasts while pentoses (xylose and arabinose), need special bacteria such as Escherichia coli to produce ethanol.

VOC Emissions

In conducting statistical analyses on the results from select VOC emissions, a randomized complete block design (RCBD) was used with the treatments (LSF and HSF) comprising two blocks. It was divided into two blocks to determine the influence of resin on select VOC emissions. The first randomized block, termed “no resin” (NR) had two treatments (control and HSF) with three replicates, while the second randomized block, termed “with resin” (WR), had three treatments (control, LSF, and HSF) with three replicates (Table 4). Physical and mechanical properties were measured only from the second block. Select VOC emissions were analyzed using a one-way analysis of variance (ANOVA) procedure.

TABLE 4
Influence of pMDI (resin) and HWE on the amount of VOC's emissions

| | | | | | |
|---|---|---|---|---|---|
| | | | | | Total select |
| Source | Phenol | Methanol | Acetaldehyde | Formaldehyde | VOC's |

mg/kg wood

| | | | | | | |
|---|---|---|---|---|---|---|
| No Resin | Control | 0.0 | 20.0 ± 3.7 | 4.7 ± 0.7 | 13.3 ± 1.6 | 38.0 ± 2.0 |
| | HSF | 0.0 | 9.5 ± 3.0 | 1.4 ± 0.4 | 13.1 ± 2.8 | 24.0 ± 2.1 |
| With Resin | Control | 0.0 | 10.2 ± 2.2 | 3.5 ± 0.2 | 8.2 ± 0.7 | 21.9 ± 1.0 |
| | LSF | 0.0 | 10.2 ± 1.8 | 0.7 ± 0.1 | 5.9 ± 0.8 | 16.8 ± 0.9 |
| | HSF | 0.0 | 7.5 ± 1.0 | 0.9 ± 0.1 | 7.0 ± 0.8 | 15.4 ± 0.6 |

In the second randomized block (WR), phenol emissions were again not detected by GC/MS for the control or either of the two SFs (LSF, HSF). Unlike the NR block, methanol emissions were found not to be significantly influenced by extraction condition. The acetaldehyde and formaldehyde emissions, however, were significantly reduced by HWE.

Comparing the control without resin (NR) vs. the control with resin (WR), the pMDI itself significantly reduces methanol and acetaldehyde emissions. When the LSF-WR is compared against control WR, there is a significant reduction in acetaldehyde and formaldehyde, but not methanol. Between LSF-WR and HSF-WR, there were higher levels of acetaldehyde and formaldehyde for the HSF, where more hemicelluloses were removed. That is due to the extraction of acetic and formic acid from hemicelluloses during HWE (Table 3). Acid formation by hot water conditions in softwood species is due to acetyl groups are contained in the C-2 and C-3 positions of the glucose and mannose units of galactoglucomannan comprising 5-10% of the weight of wood, with an average of one acetyl group for every four backbone units.

Total select VOC emissions, the sum of phenol, acetaldehyde, methanol, and formaldehyde, was 38.2 and 24.2 mg/kg wood for the control and HSF without resin, respectively. The overall percent HAP reduction as a result of extraction was 37%, indicating that the removal of hemicellulose and acetic acid play an important role in volatile organic compounds (VOC) emissions. Extracted carbohydrates also influenced total select VOC emissions in panels manufactured with resin: 22.1, 17.0, and 15.6 mg/kg wood for control, LSF, and HSF, respectively. In addition to the effect of carbohydrates, the sole use of pMDI resin caused a reduction in select VOC emissions by 29%.

Physical Properties

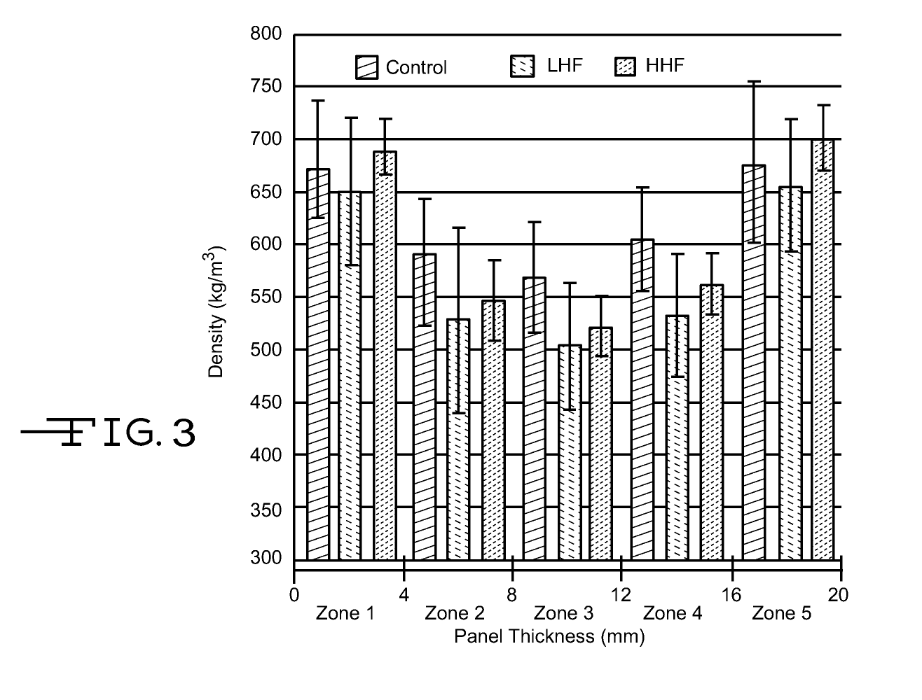

Physical properties (Table 5) were evaluated via a completely randomized design and one-way ANOVA. Panel density is highly correlated with most physical and mechanical properties. No significant difference (p=0.2423) in density was found among the treatments. However, a density gradient through the thickness of panel is developed during pressing due to heat transfer, moisture movement, wood stress relaxation, wood consolidation and resin curing. There is a strong relationship between vertical density profile (VDP) and panel properties such as dimensional stability, bending strength, and others that are of importance to OSB researchers and manufacturers. The VDP verified that among the treatments, control, LSF, and HSF, there were not significant differences (FIG. 3).

TABLE 5
Density, equilibrium moisture content (EMC) and WA/TS result summary

| | | | Thickness | Water absorption |
|---|---|---|---|---|
| Treatment | Density (k/m3) | EMC (%) | Swell (%) | (%) |
| Control | 591 ± 22 | 10.3 ± 0.1 | 9.9 ± 1.2 | 29.2 ± 3.4 |
| LSF | 596 ± 32 | 7.3 ± 0.1 | 6.0 ± 1.4 | 26.0 ± 4.9 |
| HSH | 602 ± 30 | 6.8 ± 0.1 | 3.8 ± 0.8 | 20.0 ± 1.9 |

The equilibrium moisture content (EMC) of the OSB manufactured from extracted strands was significantly lower than the control. The wettability of hot water extracted wood decreases due to the reduction of hydroxyl content, as a result of the extraction of the hemicellulose polymers.

In this experiment, the thickness swell of the extracted material was improved as a result of the reduction in the hemicellulosic amorphous polymers. In terms of OSB performance in the field, thickness swell is an important value for OSB panels, whose significant reduction would have tremendous value.

OSB panels typically absorb water faster than plywood and solid wood lumber. Decay susceptibly and mechanical properties depend on wood MC. Currently, higher levels of resin and wax are used to remediate this problem. In this experiment, the water absorption after a 24 hour water soak for the HSF panels was significantly lower than both the control and LSF panels (Table 5).

Water absorption for the control specimens after 24 hour submersion was within a range of values. OSB is a material with high variation in terms of structure and composition because of the existence of water in the cell wall, lumen, and between flakes. The reduction of water absorption in hot water extracted panels is due to less swelling (less inter flake void), lower EMC starting, less amorphous polymer (hemicelluloses extraction) and higher percentage of crystallinity. These facts indicated that extracted OSB panels had better water resistant properties, even with an increased cell wall porosity.

Mechanical Properties

Mechanical results are presented in Tables 6 and 7. The experimental statistical design utilized a RCBD, blocking into dry or wet conditions. These two blocks had three treatments each: control, LSF, and HSF.

TABLE 6
Flexural property results

| | MOR (MPa) | | SPL (MPa) | | MOE (GPa) | |
|---|---|---|---|---|---|---|
| Treatment | Dry | Wet | Dry | Wet | Dry | Wet |
| Control | 29.8 ± 5.4 | 15.9 ± 2.2 | 18.3 ± 2.1 | 9.5 ± 0.7 | 3.46 ± 0.21 | 1.65 ± 0.19 |
| LSF | 27.6 ± 3.9 | 22.7 ± 3.8 | 17.8 ± 0.9 | 13.2 ± 0.9 | 4.05 ± 0.20 | 2.53 ± 0.25 |
| HSF | 26.5 ± 4.9 | 22.7 ± 4.9 | 16.7 ± 2.3 | 13.0 ± 2.0 | 4.14 ± 0.22 | 2.67 ± 0.34 |

TABLE 7
Internal bond (IB) and APA Test S-6 results

| | IB (MPa) | | APA Test S-6 | |
|---|---|---|---|---|
| Treatment | Dry | Wet | Dry | Wet |
| Control | 0.72 ± 0.14 | 0.22 ± 0.06 | 34.5 ± 5.1 | 14.2 ± 3.1 |
| LSF | 0.69 ± 0.16 | 0.35 ± 0.11 | 31.4 ± 6.3 | 18.1 ± 3.1 |
| HSF | 0.62 ± 0.17 | 0.37 ± 0.10 | 30.7 ± 4.3 | 18.3 ± 4.1 |

Dry bending strength (MOR) and dry bending stress at the proportional limit were not significantly different among the treatments while the MOR and SPL of extracted panels in the wet condition were significantly higher than the control in a 42.6% and 36.9%, respectively. Dry MOE was significantly different among the treatments with a maximum increase of 19.7% at HSF, whereas the wet MOE also differed significantly among the treatments with a maximum increase of 61.2% at HSF.

APA Test S-6 strength under dry conditions, meant to assess bond quality, was not statistically significantly different among the treatments, but under wet conditions there was a statistically significant difference among the treatments.

Dry IB strength indicated statistically significant differences among the treatments while wet IB strength was significantly different among the treatments, with both SFs being significantly higher than the control in 63.9%. The APA Test S6 and IB indicate that adhesive performance was not affected by HWE.

Overall, the results of mechanical properties in wet condition were consistent with higher increases for the extracted material than the control specimens. This is due to lower swelling of the extracted wood (see swelling results) which would create lower swelling stresses and bond breakage than the control samples.

This study has identified that select VOC emissions can be reduced by conducting a a hot water extraction of the strands. The extract contains a mixture of hemicelluloses which may serve as a feedstock for conversion to ethanol or other chemical compounds.

The performance after exposure to moisture was significantly improved using extracted strands. MOE properties increased significantly at equivalent density values.

The ability to manufacture lower density panels and maintain/improve properties appears feasible. Extra revenue (ethanol) and reduction in transportation (lower density panel) appears possible.

Panels made with strands from which the hemicellulose has been removed show significant reductions in water absorption and thickness swell. In standard oriented strand board (OSB) production, water absorption and thickness swell are mitigated through the use of wax, which both interferes with bonding and is expensive. Due to the improved water absorption properties of the extracted panels of this invention, wax may no longer be necessary, improving both properties and economics.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A composite article comprising cellulosic strands and binder, the strands having been extracted to remove hemicellulose.

2. The composite article of claim 1 wherein the cellulosic strands are wood strands.

3. The composite article of claim 2 wherein the article has reduced production of volatile organic compound emissions compared to the same article made with non-extracted strands.

4. The composite article of claim 3 wherein the composite article comprises a panel, the wood strands are arranged in a mat, and the panel has a volatile organic compound emission of less than about 17 mg/kg of wood.

5. The composite article of claim 4 wherein the wood strands are oriented wood strands.

6. The composite article of claim 2 wherein the article has improved performance after exposure to moisture compared to the same article made with non-extracted strands.

7. The composite article of claim 6 wherein the composite article comprises a panel, the wood strands are arranged in a mat, and the panel has a thickness swell below about 8%.

8. The composite article of claim 7 wherein the panel has a thickness swell below about 4%.

9. The composite article of claim 7 wherein the wood strands are oriented wood strands.

10. The composite article of claim 1 which has a lower density compared to the same article made with non-extracted strands with equivalent or improved properties.

11. The composite article of claim 1 which does not include the use of wax.

12. The composite article of claim 1 wherein the binder is a polymer binder.

13. The composite article of claim 12 wherein the polymer binder comprises polymeric diphenylmethane diisocyanate, phenol-resorcinol-formaldehyde, or a mixture thereof.

14. A method of manufacturing a composite article comprising extracting cellulosic strands to remove hemicelluose, and forming a composite which includes the strands and a binder.

15. The method claim 14 wherein the cellulosic strands are wood strands.

16. The method of claim 14 wherein the extraction is a hot water extraction.
